(19) United States
(12) Patent Application Publication
(10) Pub. No.: US 2022/0055654 A1
(43) Pub. Date: Feb. 24, 2022

(54) Methods and Apparatus for User Interactions with Autonomous Vehicles

(71) Applicant: Nuro, Inc., Mountain View, CA (US)

(72) Inventors: Robert Irving Luan, San Jose, CA (US); Matthew Ryan Taylor, San Francisco, CA (US); Marshall Mendoza, San Francisco, CA (US); Tobias Boelter, Sunnyvale, CA (US); Paul Michael White, Mountain View, CA (US)

(73) Assignee: Nuro, Inc., Mountain View, CA (US)

(21) Appl. No.: 17/405,247

(22) Filed: Aug. 18, 2021

Related U.S. Application Data
(60) Provisional application No. 63/068,935, filed on Aug. 21, 2020.

(51) Int. Cl. B60W 60/00; H04B 1/7163; G01S 5/02; B60R 25/20; B60R 25/01; G01C 21/34

(52) U.S. Cl. CPC B60W 60/001; H04B 1/71632; G01S 5/0294; B60W 2556/45; B60R 25/01; G01C 21/3407; B60R 25/2045

(57) ABSTRACT

According to one aspect, a method includes detecting at a vehicle which includes an ultra-wideband (UWB) communications system, a presence of a first device, and pairing the vehicle and the first device, wherein pairing the vehicle and the first device causes the vehicle and the first device to communicate using UWB communications. The method also includes exchanging information between the vehicle and the first device using the UWB communications after the vehicle and the first device are paired, and performing an action using the vehicle, wherein the action is based on the information.

### PRIORITY CLAIM

This patent application claims the benefit of priority under 35 U.S.C. § 119 to U.S Provisional Patent Application No. 63/068,935, filed Aug. 21, 2020 and entitled “METHODS AND APPARATUS FOR USER INTERACTIONS WITH AUTONOMOUS VEHICLES,” which is incorporated herein by reference in its entirety.

### TECHNICAL FIELD

The disclosure relates to autonomous vehicles. More particularly, the disclosure relates to providing methods to facilitate interactions between autonomous vehicles and users of the autonomous vehicles

### BACKGROUND

The use of delivery vehicles to deliver goods to customers is becoming more prevalent as technology which allows the delivery vehicles to operate efficiently improves. The allure of having goods delivered is growing as customers are realizing that they can save time by not having to run errands to pick up the goods themselves. In addition, when customers may be risking their health and wellbeing by running errands, the ability for the customers to receive goods at their homes, particularly without having to interact with other people, may be highly appealing.

In many cases, a customer is responsible for accessing a cargo compartment of a vehicle to remove goods when the vehicle reaches a delivery location. Often, in order for the customer to gain access to the cargo compartment, the customer is required to authenticate himself or herself through the use of a physical authentication technology. Many physical authentication technologies require the customer to present a key at close range, or to touch a physical device such as a human machine interface (HMI). Such physical authentication technologies effectively demand time, energy, and physical contact from a customer or, more generally, a user.

### BRIEF DESCRIPTION OF THE DRAWINGS

The disclosure will be readily understood by the following detailed description in conjunction with the accompanying drawings in which:

FIG. 1 is a diagrammatic representation of an autonomous vehicle fleet in accordance with an embodiment.

FIG. 2 is a diagrammatic representation of a side of an autonomous vehicle in accordance with an embodiment.

FIG. 3 is a block diagram representation of an autonomous vehicle in accordance with an embodiment.

FIG. 4 is a block diagram representation of a vehicle and a customer device communicating using ultra-wideband (UWB) communications in accordance with an embodiment.

FIG. 5 is a process flow diagram which illustrates a first method of pairing a UWB-enabled device with a UWB-enabled vehicle in accordance with an embodiment.

FIG. 6 is a process flow diagram which illustrates a second method of pairing a UWB-enabled device with a UWB-enabled vehicle in accordance with an embodiment.

FIG. 7 is a diagrammatic representation of a vehicle paired to a customer device such that the vehicle may exhibit autonomous behaviors upon pairing in accordance with an embodiment.

FIG. 8 is a diagrammatic representation of a vehicle paired to a customer device such that the customer device may control actions of the vehicle upon pairing in accordance with an embodiment.

FIG. 9 is a process flow diagram which illustrates a method of completing interactions between a vehicle and a customer in accordance with an embodiment.

FIG. 10 is a diagrammatic representation of a vehicle paired to a customer device such that the vehicle may perform localization and direct actions to the customer device based on the localization in accordance with an embodiment.

FIG. 11 is a diagrammatic representation of a vehicle paired to a customer device such that the vehicle may communicate with the customer device to predict a path or trajectory of the customer device in accordance with an embodiment.

FIG. 12A is a diagrammatic representation of a vehicle and a customer device at a time t1 in accordance with an embodiment.

FIG. 12B is a diagrammatic representation of a vehicle and a customer device, e.g., vehicle 1201 and customer device 1246 of FIG. 12A, at a time t2 in accordance with an embodiment.

FIG. 12C is a diagrammatic representation of a vehicle and a customer device, e.g., vehicle 1201 and customer device 1246 of FIG. 12A, at a time t3 substantially immediately after time t2 in accordance with an embodiment.

FIG. 12D is a diagrammatic representation of a vehicle and a customer device, e.g., vehicle 1201 and customer device 1246 of FIG. 12A, at a time t4 in accordance with an embodiment.

FIG. 13 is a process flow diagram which illustrates a method of positioning a vehicle relative to a customer device based on a predicted trajectory of the customer device in accordance with an embodiment.

FIG. 14 is a diagrammatic representation of a vehicle with UWB capabilities which may communicate with an overall system that includes a UWB system which includes at least one UWB tag in accordance with an embodiment.

FIG. 15A is a diagrammatic representation of a vehicle interacting with UWB tags at a time t1 in accordance with an embodiment.

FIG. 15B is a diagrammatic representation of a vehicle interacting with UWB tags, e.g., vehicle 1501 and UWB tags 1574 of FIG. 15A, at a time t2 in accordance with an embodiment.

FIG. 16 is a process flow diagram which illustrates a method of a vehicle interacting with UWB tags in accordance with an embodiment.

FIG. 17 is a process flow diagram which illustrates a method of a vehicle interacting with a UWB-enabled device to cause an action associated with the vehicle to be performed in accordance with an embodiment.

FIG. 18 is a process flow diagram which illustrates a method of a vehicle performing an action in response to obtaining authentication information from a UWB-enabled device in accordance with an embodiment.

### DESCRIPTION OF EXAMPLE EMBODIMENTS

### General Overview

In accordance with one embodiment, a method includes detecting at a vehicle which includes an ultra-wideband (UWB) communications system, a presence of a first device, and pairing the vehicle and the first device, wherein pairing the vehicle and the first device causes the vehicle and the first device to communicate using UWB communications. The method also includes exchanging information between the vehicle and the first device using the UWB communications after the vehicle and the first device are paired, and performing an action using the vehicle, wherein the action is based on the information.

In accordance with another aspect, a vehicle includes a chassis, a propulsion system carried on the chassis, and a navigation system carried on the chassis. The propulsion system is configured to enable the vehicle to travel, and the navigation system cooperates with the propulsion system to navigate the vehicle. The vehicle also includes a UWB system carried on the chassis. The UWB system the UWB system is configured to support UWB communications and to process information included in the UWB communications to cause the vehicle to perform an action.

In accordance with yet another aspect, a system includes a vehicle and a first UWB device. The vehicle includes an ultra-wideband (UWB) system configured to support UWB communications and to process information included in the UWB communications to cause the vehicle to perform an action. The first UWB device is arranged to pair with the vehicle when the first UWB device is within a vicinity of the vehicle. When the first UWB device is paired with the vehicle, the vehicle and the first UWB device exchange information using UWB communications, wherein the vehicle is configured to perform an action based on the information. The action may involve moving or otherwise positioning the vehicle and/or opening a compartment on the vehicle.

A device in the possession of a user or an individual may be substantially automatically paired to a vehicle, e.g., an autonomous vehicle, to enable two-way interactions between the device and the vehicle when the device and the vehicle are in proximity of each other. The pairing may be achieved through ultra-wideband communications, and may enable pairing to be accomplished without requiring physical contact of the individual with the vehicle. Interactions enabled via UWB communications may include hands-free interactions and passive user authentication, as well as a variety of contextual autonomous behaviors of the vehicle based on the location of a user in possession of a device paired to the vehicle. In some instances, technologies including, but not limited to including, Bluetooth, internet, and local network communications may be used to substantially initiate a UWB pairing.

### Description

The ability for an individual to interact with a vehicle, e.g., to interact with an autonomous or driverless vehicle to gain access to a cargo compartment of the vehicle, in a secure, physically contact-free manner reduces the likelihood that the individual acquires germs, pathogens, microbes, and/or other contaminants that may be present on the vehicle. For example, if an individual may cause a door or a covering on a compartment of a vehicle to open and close without having to physically touch the vehicle, the individual is less likely to become infected with or otherwise tainted with any substances on the vehicle. In addition, if an individual may be substantially passively authenticated to access compartments of a vehicle, the efficiency with which the individual may access compartments may be enhanced.

In one embodiment, an individual may interact with a vehicle in a secure manner and without having to physically touch the vehicle by engaging in ultra-wideband (UWB) interactions with the vehicle. UWB technology, such as technology in conformance with Institute of Electrical and Electronic Engineers (IEEE) 802.15.4/4z, generally enables two-way location and authentication to occur. UWB technology may enable a vehicle to pair with an individual, i.e., an individual in possession of or having access to, a device with UWB capabilities, such that the individual may interact with the vehicle to essentially control the vehicle and/or features associated with the vehicle.

UWB is a communications technology that utilizes a relatively wide bandwidth. Typically, UWB is a wireless communications technology, and is used to support relatively high data transmission rates or speeds, while using relatively low power and with relatively little interference over short ranges. UWB radio technology transmits and/or receives short time domain pulses, and UWB signals may be defined as signals with a bandwidth that is higher than approximately 0.5 Gigahertz (GHz).

By allowing an individual to interact with a vehicle using UWB technology, or any other suitable technology which enables localization and ranged authentication, the individual may generally be authenticated substantially automatically, as for example when the vehicle and the individual are in range of each other, and may then efficiently communicate with the vehicle. Efficient communications and/or interactions between an individual and a vehicle may enable the individual to save time and energy, and may also prevent the individual from having to physically touch the vehicle. The efficient communications and/or interactions may also reduce the amount of time a vehicle, e.g., a vehicle that belongs to a fleet of vehicles, spends with the individual and, hence, effectively enables the vehicle to be scheduled to perform more tasks.

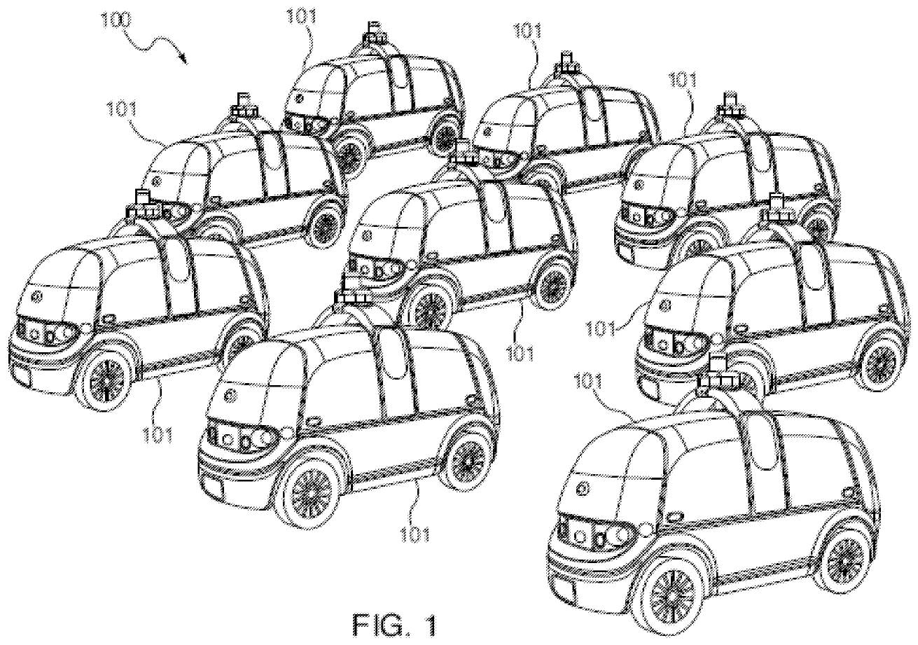

A vehicle that supports UWB communications may be an autonomous vehicle that is part of a fleet of vehicles. Referring initially to FIG. 1, an autonomous vehicle fleet which includes one or more vehicles that allow two-way interactions between vehicles and a user will be described in accordance with an embodiment. An autonomous vehicle fleet 100 includes a plurality of autonomous vehicles 101, or robot vehicles. Autonomous vehicles 101 are generally arranged to transport and/or to deliver cargo, items, and/or goods. Autonomous vehicles 101 may be fully autonomous and/or semi-autonomous vehicles. In general, each autonomous vehicle 101 may be a vehicle that is capable of travelling in a controlled manner for a period of time without intervention, e.g., without human intervention. As will be discussed in more detail below, each autonomous vehicle 101 may include a power system, a propulsion or conveyance system, a navigation module, a control system or controller, a communications system, a processor, and a sensor system.

Dispatching of autonomous vehicles 101 in autonomous vehicle fleet 100 may be coordinated by a fleet management module (not shown). The fleet management module may dispatch autonomous vehicles 101 for purposes of transporting, delivering, and/or retrieving goods or services in an unstructured open environment or a closed environment.

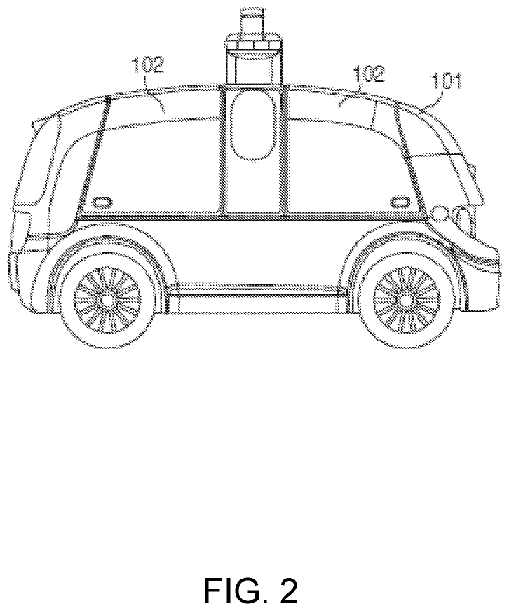

FIG. 2 is a diagrammatic representation of a side of an autonomous vehicle, e.g., one of autonomous vehicles 101 of FIG. 1, in accordance with an embodiment. Autonomous vehicle 101, as shown, is a vehicle configured for land travel. Typically, autonomous vehicle 101 includes physical vehicle components such as a body or a chassis, as well as conveyance mechanisms, e.g., wheels. In one embodiment, autonomous vehicle 101 may be relatively narrow, e.g., approximately two to approximately five feet wide, and may have a relatively low mass and relatively low center of gravity for stability. Autonomous vehicle 101 may be arranged to have a working speed or velocity range of between approximately one and approximately forty-five miles per hour (mph), e.g., approximately twenty-five miles per hour. In some embodiments, autonomous vehicle 101 may have a substantially maximum speed or velocity in range between approximately thirty and approximately ninety mph.

Autonomous vehicle 101 includes a plurality of compartments 102. Compartments 102 may be assigned to one or more entities, such as one or more customer, retailers, and/or vendors. Compartments 102 are generally arranged to contain cargo, items, and/or goods. Typically, compartments 102 may be secure compartments, or compartments which may be locked. It should be appreciated that the number of compartments 102 may vary. That is, although two compartments 102 are shown, autonomous vehicle 101 is not limited to including two compartments 102.

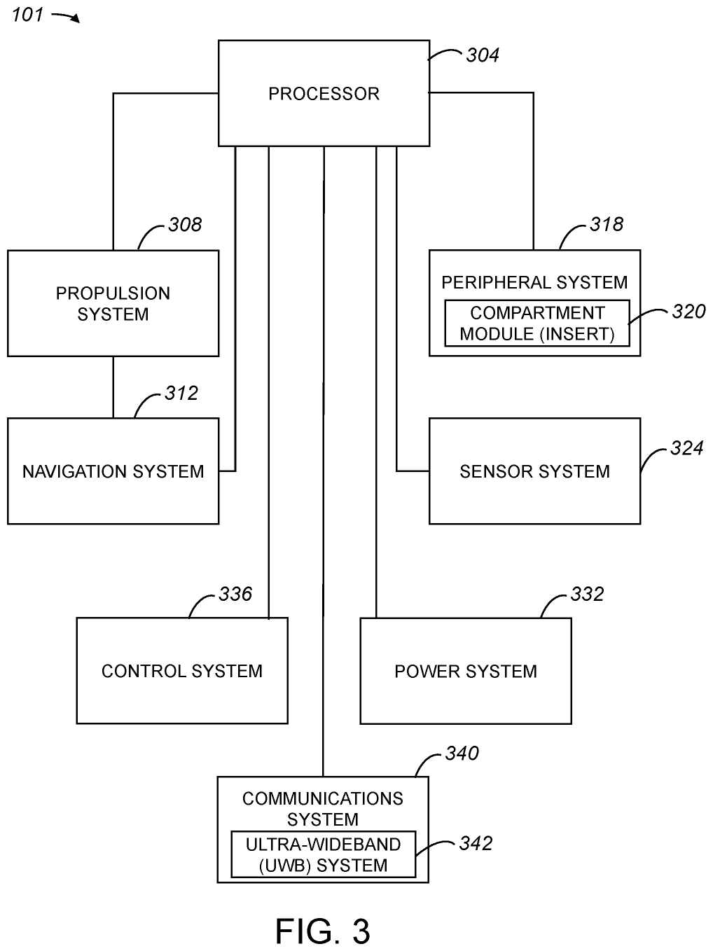

FIG. 3 is a block diagram representation of an autonomous vehicle, e.g., autonomous vehicle 101 of FIG. 1, in accordance with an embodiment. An autonomous vehicle 101 includes a processor 304, a propulsion system 308, a navigation system 312, a sensor system 324, a power system 332, a control system 336, and a communications system 340. It should be appreciated that processor 304, propulsion system 308, navigation system 312, sensor system 324, power system 332, and communications system 340 are all coupled to a chassis or body of autonomous vehicle 101.

Processor 304 is arranged to send instructions to and to receive instructions from or for various components such as propulsion system 308, navigation system 312, sensor system 324, power system 332, and control system 336. Propulsion system 308, or a conveyance system, is arranged to cause autonomous vehicle 101 to move, e.g., drive. For example, when autonomous vehicle 101 is configured with a multi-wheeled automotive configuration as well as steering, braking systems and an engine, propulsion system 308 may be arranged to cause the engine, wheels, steering, and braking systems to cooperate to drive. In general, propulsion system 308 may be configured as a drive system with a propulsion engine, wheels, treads, wings, rotors, blowers, rockets, propellers, brakes, etc. The propulsion engine may be a gas engine, a turbine engine, an electric motor, and/or a hybrid gas and electric engine.

Navigation system 312 may control propulsion system 308 to navigate autonomous vehicle 101 through paths and/or within unstructured open or closed environments. Navigation system 312 may include at least one of digital maps, street view photographs, and a global positioning system (GPS) point. Maps, for example, may be utilized in cooperation with sensors included in sensor system 324 to allow navigation system 312 to cause autonomous vehicle 101 to navigate through an environment.

Sensor system 324 includes any sensors, as for example LiDAR, radar, ultrasonic sensors, microphones, altimeters, and/or cameras. Sensor system 324 generally includes onboard sensors which allow autonomous vehicle 101 to safely navigate, and to ascertain when there are objects near autonomous vehicle 101. In one embodiment, sensor system 324 may include propulsion systems sensors that monitor drive mechanism performance, drive train performance, and/or power system levels.

Power system 332 is arranged to provide power to autonomous vehicle 101. Power may be provided as electrical power, gas power, or any other suitable power, e.g., solar power or battery power. In one embodiment, power system 332 may include a main power source, and an auxiliary power source that may serve to power various components of autonomous vehicle 101 and/or to generally provide power to autonomous vehicle 101 when the main power source does not have the capacity to provide sufficient power.

Communications system 340 allows autonomous vehicle 101 to communicate, as for example, wirelessly, with a fleet management system (not shown) that allows autonomous vehicle 101 to be controlled remotely. Communications system 340 generally obtains or receives data, stores the data, and transmits or provides the data to a fleet management system and/or to autonomous vehicles 101 within a fleet 100. The data may include, but is not limited to including, information relating to scheduled requests or orders, information relating to on-demand requests or orders, and/or information relating to a need for autonomous vehicle 101 to reposition itself, e.g., in response to an anticipated demand. In one embodiment, communications system 340 includes a UWB system 342 which allows vehicle 101 to communicate with a customer or a user, e.g., a customer or a user with a device which is capable of sending and receiving communications over UWB. UWB system 342 may generally include, but is not limited to including, a transmitter, a receiver, a pulse generator, and a processing arrangement.

In some embodiments, control system 336 may cooperate with processor 304 to determine where autonomous vehicle 101 may safely travel, and to determine the presence of objects in a vicinity around autonomous vehicle 101 based on data, e.g., results, from sensor system 324. In other words, control system 336 may cooperate with processor 304 to effectively determine what autonomous vehicle 101 may do within its immediate surroundings. Control system 336 in cooperation with processor 304 may essentially control power system 332 and navigation system 312 as part of driving or conveying autonomous vehicle 101. Additionally, control system 336 may cooperate with processor 304 and communications system 340 to provide data to or obtain data from other autonomous vehicles 101, a management server, a global positioning server (GPS), a personal computer, a teleoperations system, a smartphone, or any computing device via the communication module 340. In general, control system 336 may cooperate at least with processor 304, propulsion system 308, navigation system 312, sensor system 324, and power system 332 to allow vehicle 101 to operate autonomously. That is, autonomous vehicle 101 is able to operate autonomously through the use of an autonomy system that effectively includes, at least in part, functionality provided by propulsion system 308, navigation system 312, sensor system 324, power system 332, and control system 336.

In one embodiment, autonomous vehicle 101 includes a peripheral system 318. Peripheral system 318 may generally includes components which are carried on autonomous vehicle 101, and may be controlled through control system 336 and/or communications system 340. Components may include, as shown, a compartment module or insert 320 which may be located or otherwise positioned in a compartment of autonomous vehicle 101, e.g., compartment 102 of FIG. 2. Compartment module 320 may include, but is not limited to including, temperature-controlled modules and/or modules which include individually securable sections or lockers. Compartment module 320 may be arranged to utilize UWB communications. By way of example, a temperature associated with compartment module 320 and/or access to lockers of compartment module 320 may be substantially controlled through the use of UWB communications.

As will be appreciated by those skilled in the art, when autonomous vehicle 101 operates autonomously, vehicle 101 may generally operate, e.g., drive, under the control of an autonomy system. That is, when autonomous vehicle 101 is in an autonomous mode, autonomous vehicle 101 is able to generally operate without a driver or a remote operator controlling autonomous vehicle. In one embodiment, autonomous vehicle 101 may operate in a semi-autonomous mode or a fully autonomous mode. When autonomous vehicle 101 operates in a semi-autonomous mode, autonomous vehicle 101 may operate autonomously at times and may operate under the control of a driver or a remote operator at other times. When autonomous vehicle 101 operates in a fully autonomous mode, autonomous vehicle 101 typically operates substantially only under the control of an autonomy system. The ability of an autonomous system to collect information and extract relevant knowledge from the environment provides autonomous vehicle 101 with perception capabilities. For example, data or information obtained from sensor system 324 may be processed such that the environment around autonomous vehicle 101 may effectively be perceived.

In one embodiment, when a vehicle that includes a UWB system, such as vehicle 101 which includes UWB system 342, is within range of a device which recognizes UWB communications, the UWB system and the device may begin to communicate using UWB communications. For example, the UWB system of the vehicle and the device may substantially automatically begin an authentication process to authenticate a possessor of the device as having rights to cargo carried on the vehicle.

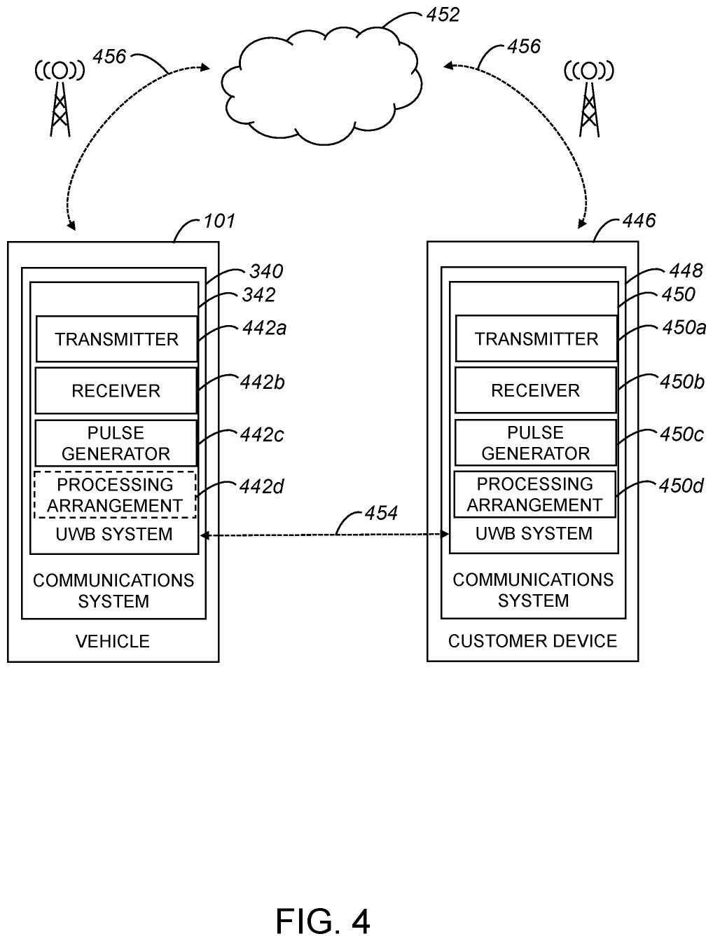

FIG. 4 is a block diagram representation of a vehicle and a customer device communicating using ultra-wideband (UWB) communications in accordance with an embodiment. Vehicle 101 includes UWB system 342 which is part of communications system 340. UWB system 342 may include a transmitter 442a, a receiver 442b, a pulse generator 442c, and an optional processing arrangement 442d. Transmitter 442a, which may include an antenna, is configured to transmit UWB signals, and receiver 442b, which may also include an antenna, is configured to receive UWB signals. Pulse generator 442c may include, for example, a Gaussian filter or a differentiator. Optional processing arrangement 442d may include hardware and/or software which processes UWB signals. Processing arrangement 442d is optional because processing may be provided by other systems in vehicle 101.

Vehicle 101 may generally communicate with a customer device 446, which may be a device in the possession of a customer who has requested that vehicle 101 drives or otherwise propels itself to a location of the customer. Customer device 446 may be a device such as a smartphone, a tablet, a smart watch, and/or a computing device. Communications across a network 456 which includes a cloud server 452 may occur between vehicle 101 and customer device 446 Such communications may include, but are not limited to including, wireless communications such as cellular communications, LTE, communications, and/or 3G/4G/5G communications.

Customer device 446 includes a communications system 448 which is arranged to support communications over network 456. Communications system 448 includes a UWB system 450. UWB system 450 generally includes a transmitter 450a, a receiver 450b, a pulse generator 450c, and a processing arrangement 450d.

When vehicle 101 is in proximity to a customer device 446, UWB system 342 and UWB system 450 may attempt to communicate substantially directly in a wireless manner, as indicated by wireless communications link 454. That is, UWB system 342 may attempt to engage UWB system 450, and vice versa. UWB system 342 may be considered to be in proximity to UWB system 450 when UBW system 342 is within a line-of-sight of UWB system 450 at a distance of up to approximately two hundred meters, It should be appreciated, however, that that distance may be less than or more than approximately two hundred meters. In one embodiment, UWB system 342 and UWB system 450 may pair when they are at a distance of less than approximately fifty meters apart. In one embodiment, vehicle 101 and customer device 446 may have previously been configured to substantially recognize each other via UWB communications and, hence, may attempt to communicate when vehicle 101 and customer device 446 are determined to be in proximity to each other. In another embodiment, vehicle 101 and customer device 446 may be in communication through network 456 until vehicle and customer device 446 are determined to be within a particular distance from each other, at which point communications switch from network 456 to communications over wireless communications link 454 which supports UWB communications.

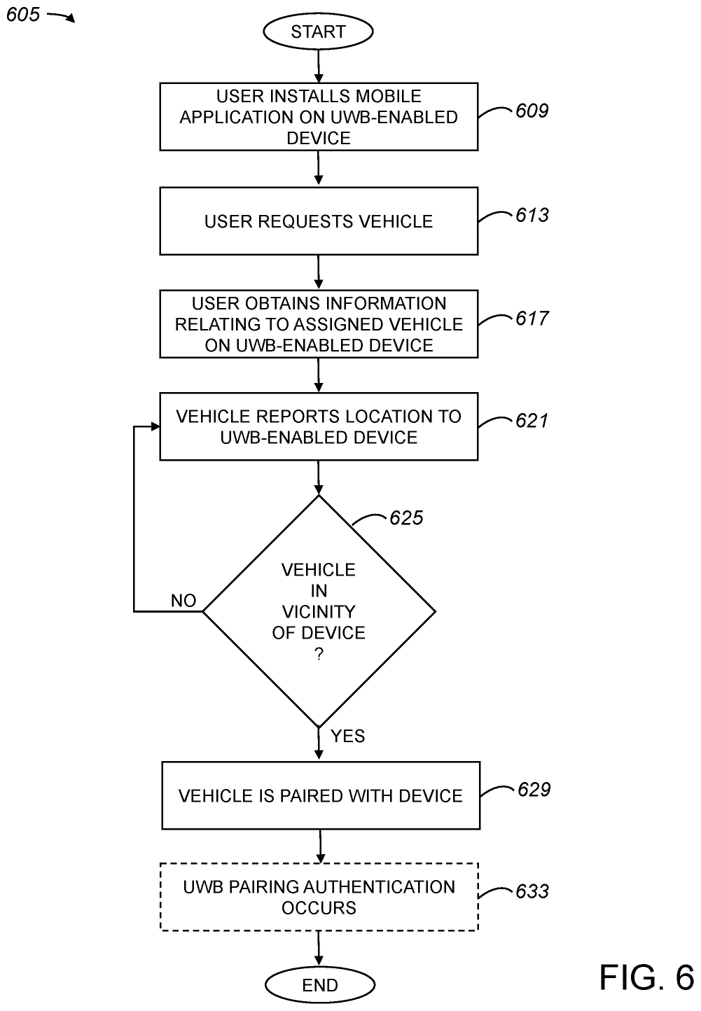

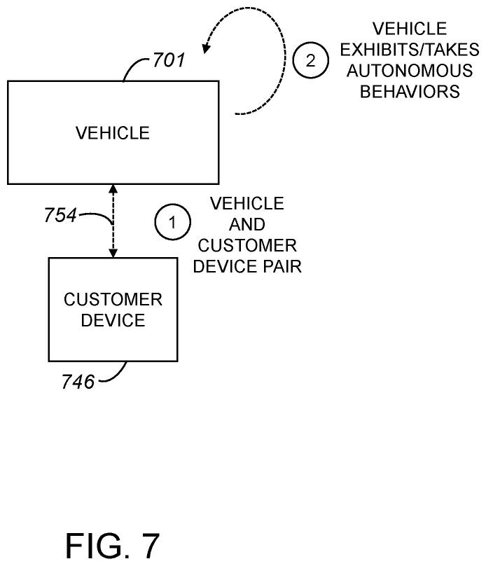

When vehicle 101 and customer device 446 are both UWB-enabled or UWB-capable, i.e., may support UWB communications and the transmission of data using UWB, pairing may occur in any suitable manner. With reference to FIGS. 6 and 7, two method of pairing a vehicle and a customer device which each support UWB communications will be described in accordance with embodiments.

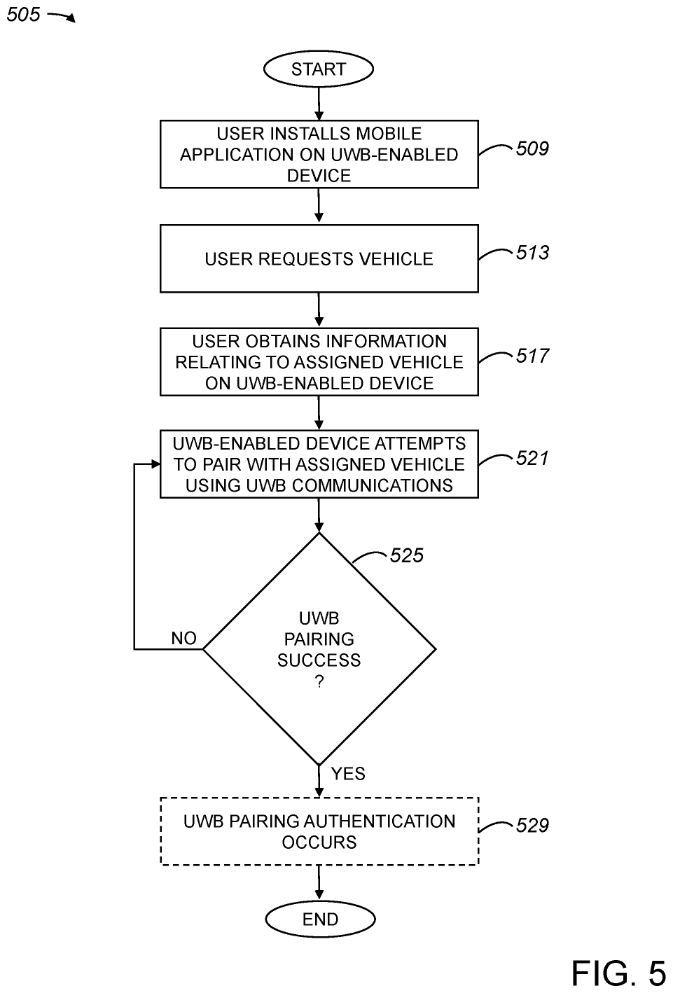

FIG. 5 is a process flow diagram which illustrates a first method of pairing a UWB-enabled device with a UWB-enabled vehicle in accordance with an embodiment. A method 505 of pairing a UWB-enabled device with a UWB-enabled vehicle begins at a step 509 in which a user, e.g., a customer or a potential customer, installs an application on his or her UWB-enabled device. The application, which may be a mobile application, generally provides the user with an ability to request a vehicle, e.g., an autonomous delivery vehicle such as vehicle 101 of FIGS. 2 and 3. The application may be pushed to the UWB-enabled device, or the application may be located and installed by the user on the UWB-enabled device. When the application is pushed to the UWB-enabled device, the application may be pushed when the user is at a particular location, as for example in the vicinity of a vehicle that may be requested using the application, or the application may be pushed when it is determined that the user may be interested in the application.

In a step 513, the user requests a vehicle to come to a particular location. That is, the user requests the physical presence of the vehicle. The request may be made by the user using the application installed on the device in step 509. The request for a vehicle may be part of a request for a delivery or a service. The particular location may be a physical location associated the user, or may be a physical location. The request may be made via a network and/or a cloud server, as for example network 456 and cloud server 452 of FIG. 4, which allows the device to communicate with the vehicle.

Once the user requests the vehicle, the user obtains information relating to the requested or assigned vehicle in a step 517. The information may be obtained via a network and/or a cloud server, and may be received by the application on the device. The information may vary widely, and typically includes, but is not limited to including, a vehicle identifier (ID) that uniquely identifies the vehicle which is to be provided to the user in response to the request.

The device attempts to pair to the assigned vehicle in a step 521 using UWB communications. In one embodiment, the device and/or the assigned vehicle may begin attempting to pair upon the assignment of the vehicle. A determination is made in a step 525 as to whether the pairing of the device and the assigned vehicle is successful.

If the determination in step 525 is that there has been no successful pairing between the device and the assigned vehicle, the indication is typically that the device and the assigned vehicle are not in close proximity to each other. However, if the determination is that there has been no successful pairing, the indication may be that either the device or the assigned vehicle is pairing or communicating with another UWB device, or that either the device or the assigned vehicle have a communications failure, As will be appreciated by those skilled in the art, UWB communications and, hence, pairing of the device and the assigned vehicle, are generally successful when UWB systems or endpoints are within a predetermined distance from each other. That is, pairing occurs when the device is in a UWB communications range of the assigned vehicle and/or when the assigned vehicle is in a UWB communications range of the device. If there has been no successful pairing, process flow returns to step 521 in which the device continues to attempt to pair with the assigned vehicle.

Alternatively, if the determination in step 525 is that the pairing has been a success, the implication is that the vehicle is in the vicinity of the device, e.g., the vehicle has arrived at a physical location associated with the user. Accordingly, in an optional step 529, pairing authentication occurs between the device and the vehicle. Step 529 is optional, as it may not be necessary to authenticate the device. The pairing authentication may include, but is not limited to including, the user obtaining authentication instructions or information on the application. Such information may be obtained from a cloud server on a network. When the user is effectively authenticated based on pairing authentication, then the user may essentially be allowed to interact with the vehicle. In one embodiment, pairing authentication may involve the user requesting, using the device, an authentication step or signal, and leveraging local sensing capabilities of the vehicle. Leveraging local sensing capabilities of the vehicle may includes using cameras on the vehicle to enable the user to use gestures and/or other visual cues to provide additional authentication. The method of pairing a UWB-enabled device with a UWB-enabled vehicle is completed after pairing and an optional authentication occurs. It should be appreciated that once pairing and an optional authentication occur, information such as localization information and secure data may be exchanged using UWB communications.

In lieu of substantially continuously attempt to pair a UWB-enabled device with a UWB-enabled vehicle, pairing may be attempted substantially only when the vehicle is known to be in the vicinity of the device. FIG. 6 is a process flow diagram which illustrates a second method of pairing a UWB-enabled device with a UWB-enabled vehicle in accordance with an embodiment. A method 605 of pairing a UWB-enabled device with a UWB-enabled vehicle begins at a step 609 in which a user installs an application on his or her UWB-enabled device. The application, which may be a mobile application, generally provides the user with an ability to request a vehicle, e.g., an autonomous delivery vehicle such as vehicle 101 of FIGS. 2 and 3. The application may be pushed to the UWB-enabled device, or the application may be located and installed by the user on the UWB-enabled device.

In a step 613, the user requests a vehicle to come to a particular location. That is, the user requests the physical presence of the vehicle. The request may be made by the user using the application installed on the device in step 609.

After the user requests the vehicle, the user obtains information relating to the requested or assigned vehicle in a step 617. The information, which may include a vehicle ID that identifies the assigned vehicle, may be obtained via a network and/or a cloud server, and may be received by the application on the device.

In a step 621, the vehicle reports its current physical location to the device, e.g., to the application installed on the device through a network and/or a cloud server. The vehicle may provide its current physical location to the device periodically, or may provide its current physical location when the vehicle reaches a physical location associated with the user.

It is determined in a step 625 whether the reported location of the vehicle indicates that the vehicle is in the vicinity of the device. Such a determination may include, but is not limited to including, determining whether the vehicle is within a predetermined range of the device and/or whether the vehicle and the device are able to communicate substantially directly with each other using UWB communications. If the determination is that the vehicle is not in the vicinity of the device, process flow returns to step 621 in which the vehicle reports its current physical location to the device.

Alternatively, if it is determined in step 625 that the vehicle is in the vicinity of the device, the indication is that the vehicle and the device may be pair. As such, in a step 629, the vehicle is paired with the device. Process flow moves from step 629 to an optional step 633 in which pairing authentication occurs between the device and the vehicle. The pairing authentication may include, but is not limited to including, the user obtaining authentication instructions or information on the application. The method of pairing a UWB-enabled device with a UWB-enabled vehicle is completed once pairing and/or an optional pairing authentication occurs.

When a customer device which has UWB capabilities is successfully paired and/or authenticated with a vehicle which has UWB capabilities, the vehicle may perform actions including, but not limited to including, autonomous behaviors. FIG. 7 is a diagrammatic representation of a vehicle paired to a customer device such that the vehicle may exhibit autonomous behaviors upon pairing in accordance with an embodiment. A customer device 746, which generally includes a UWB system that supports UWB communications, may request the presence of a vehicle 701. Vehicle 701 may be an autonomous vehicle, e.g., an autonomous delivery vehicle, which has UWB capabilities.

When vehicle 701 and customer device 746 are within range of each other such that vehicle 701 and customer device 746 may communicate substantially directly using a wireless UWB link or channel 754, vehicle 701 and customer device 746 may pair with each other. In one embodiment, in order for vehicle 701 and customer device 746 to become aware of each other, they typically have preexisting information about each other. The preexisting information may be provided using, for example, an application on customer device 746 which allows customer device 746 to provide information to and to obtain information from vehicle 701 through the cloud. The preexisting information may include, but is not limited to including, a unique identifier number, a random code sequence, and/or other related information. Customer device 746 and vehicle 701 may become aware of each other by communicating the preexisting information through UWB communications such that customer device 746 and vehicle 701 each recognize the sequence of the other. The pairing of vehicle 701 and customer device 746 may include authentication measures, or measures taken to substantially ensure that a customer in possession of customer device 746 is entitled or otherwise allowed to interact with vehicle 701.

In one embodiment, the pairing of vehicle 701 and customer device 746 may be substantially accomplished using information which was previously provided. By way of example, an application (not shown) associated with vehicle 701 may be used on customer device 746 to provide customer account information to vehicle 701 or an enterprise associated with vehicle 701. A customer identifier established by such an application (not shown) may be associated with customer device 746, and may be stored with respect to customer device 746 and vehicle 701, or a server such as a cloud server associated with vehicle 701. When vehicle 701 is in proximity to customer device 746, customer device 746 may initiate sending or providing the customer identifier which may be obtained and recognized by vehicle 701. It should be appreciated that vehicle 701 may also initiate sending or providing the customer identifier to customer device 746 when vehicle 701 is in proximity to customer device 746.

Once vehicle 701 and customer device 746 are paired, vehicle 701 may exhibit, or otherwise take, autonomous actions or behaviors. For example, vehicle 701 may activate and actuate components including, but not limited to including, doors on compartments, shelves, lights, audio speakers, and/or a drivetrain. Doors on vehicle 701 may be arranged to unlock and/or to open once customer device 746 is detected to be within a particular distance or location relative to vehicle 701. Lights and/or display screens on or in vehicle 701 may be activated, as for example in a directional manner, to facilitate the use of vehicle 701 by a customer. Lights may be used to facilitate customer identification or discovery from range, and to provide instructions or feedback to a customer. When vehicle 101 includes speakers to play sounds and/or words, such sounds and/or words may be substantially played, e.g., in a directional manner, to facilitate identification or discover of a customer, to provide the customer with instructions or feedback, and/or to support navigation for vision-impaired customers. Additional autonomous actions or behaviors that may be exhibited by vehicle 101 include the vehicle avoiding particular actions or making particular movements based on a position of a customer in order to avoid collisions and, hence, improve safety. In one embodiment, vehicle 701 may use information relating to a location of a customer to facilitate and/or to guide microphone beamforming when vehicle 701 is used to support audio recordings.

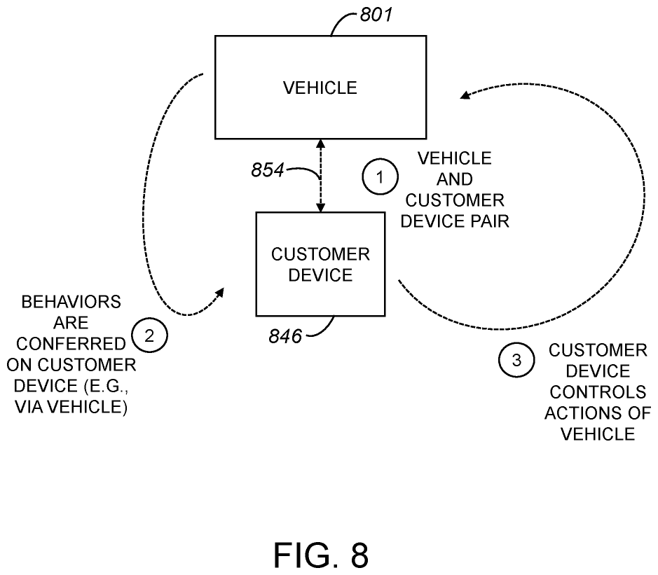

When a customer device which has UWB capabilities is successfully paired and/or authenticated with a vehicle which has UWB capabilities, the customer device may be used to effectively control actions of the vehicle. With reference to FIG. 8, the use of a customer device to control actions of a vehicle upon pairing the customer device and the vehicle will be described in accordance with an embodiment. A customer device 846, which generally includes a UWB system that supports UWB communications, may request the presence of a vehicle 801. Vehicle 801 may be an autonomous vehicle, e.g., an autonomous delivery vehicle, which has UWB capabilities.

When vehicle 801 and customer device 846 are within range of each other such that vehicle 801 and customer device 846 may communicate substantially directly using a wireless UWB link or channel 854, vehicle 801 and customer device 846 may pair with each other. The pairing of vehicle 801 and customer device 846 may include authentication measures, or measures taken to substantially ensure that a customer in possession of customer device 846 is entitled or otherwise allowed to interact with vehicle 801.

Once vehicle 801 and customer device 846 are paired, vehicle 801 may effectively confer behaviors on customer device 846 to enable customer device 846 to control some actions of vehicle 801. That is, vehicle 801 may effectively allow customer device 846 to be used to control some actions of vehicle 801. The behaviors may be conferred, in one embodiment, by vehicle 801 using wireless link or channel 854. Behaviors or actions that may be controlled by a customer in possession of customer device 846 include, but are not limited to including, physical and virtual actions such as opening and/or closing of actuated doors on vehicle 801, motions of vehicle 801, lights of vehicle 801, and communications of vehicle data.

Customer device 846 mat be used as a remote controller to command behavior of vehicle 801. In one embodiment, localization information associated with the location of customer device 846, which may be shared using wireless link or channel 854, may enable for directional control relative to a position and an orientation of customer device 846.

Customer device 846 may also be used to enable a virtual-reality or an augmented-reality experience. Localization information may support tracking of a vehicle position to enable and/or to otherwise assist augmented reality applications such as visual overlays.

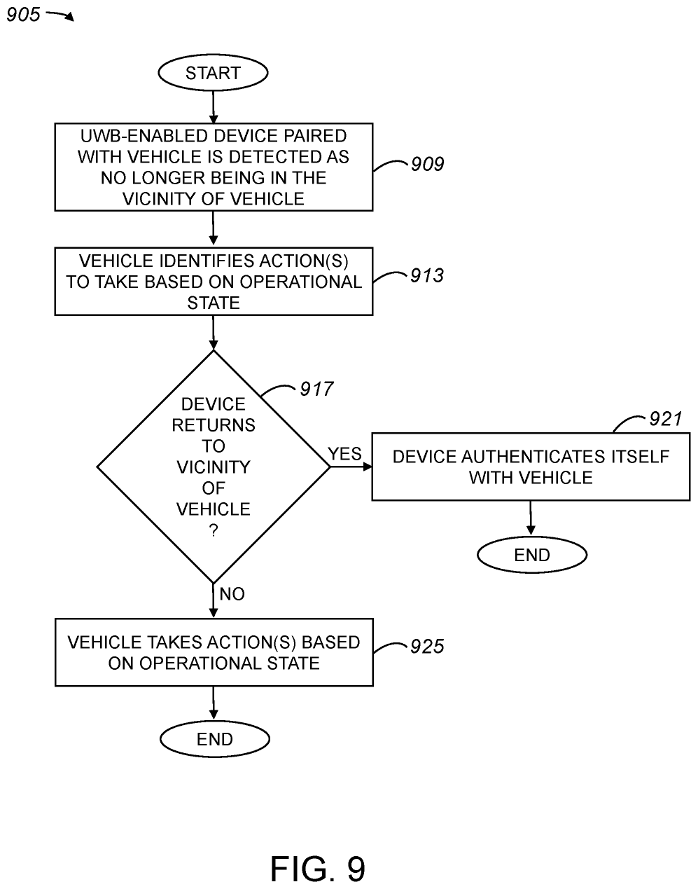

In some situations, a user or a customer with a customer device that is paired with a vehicle at a particular physical location may depart the physical location without substantially notifying the vehicle, or otherwise communicating to the vehicle that the user or customer has completed his or her interaction with the vehicle. FIG. 9 is a process flow diagram which illustrates a method of completing interactions between a vehicle and a customer that are paired to support UWB communications in accordance with an embodiment. A method 905 of completing an interaction between a customer and a vehicle without a completion indication from the customer begins at a step 909 in which a UWB-enabled customer device which is paired with a vehicle is detected as no longer being in the vicinity of the vehicle. The vehicle may detect, for example, that the vehicle is no longer able to communicate with the customer device using UWB communications.

In a step 913, the vehicle identifies one or more actions that the vehicle may take based on its operational state. For example, the vehicle may determine that its operational sate is such that at least one compartment door is open, in which case the vehicle may determine that an appropriate action is to cause the doors to close, and then to prepare to autonomously depart from its current location. In general, the vehicle may identify a suitable action to include closing and securing doors in the event that the doors are open.

A determination is made in a step 917 as to whether the customer device has returned to the vicinity of the vehicle, e.g., whether the customer device is once again paired with or attempting to pair with the vehicle. If the determination in step 917 is that the customer device has not returned to the vicinity of the vehicle, then the vehicle takes at least one action identified in step 913. That is, the vehicle takes at least one action based on its operational state, and the method of completing an interaction between a customer and a vehicle is completed.

Alternatively, if it is determined in step 917 that the customer device is once again in the vicinity of the vehicle, then the device may authenticate itself with the vehicle in a step 921. Once the customer device has authenticated itself with the vehicle, the customer device may be used to facilitate interactions between a customer and the vehicle, and the method of completing an interaction between a customer and a vehicle is terminated.

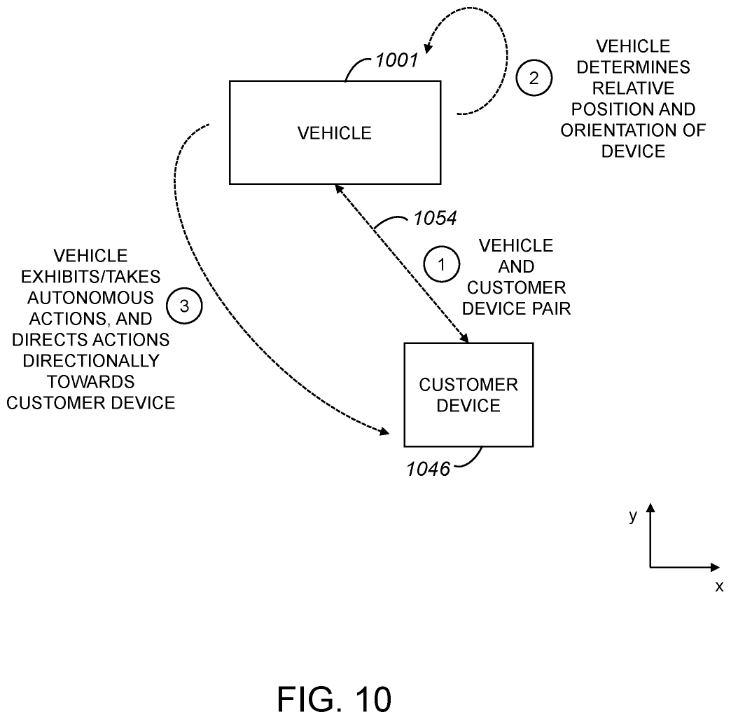

As mentioned above, localization may be performed, using UWB communications, on a UWB-enabled device and a UWB-enabled vehicle that are paired. with respect to a customer device. It should be appreciated that localization may generally involve the implementation of computations and/or algorithms to estimate a location as well as an orientation of a device or a vehicle based on information obtained from sensors on the device or the vehicle. FIG. 10 is a diagrammatic representation of a vehicle paired to a customer device such that the vehicle may perform localization and direct actions to the customer device based on the localization in accordance with an embodiment. A UWB-enabled vehicle 1001 and a UWB-enabled customer device 1046 may be paired to enable UWB communications over wireless link or channel 1054. Once vehicle 1001 and device 1046 are paired, vehicle 1001 may determine the relative position and orientation of device 1046. In one embodiment, such a determination may be made based on localization information obtained using sensors of vehicle 1001 and/or information provided by device 1046 through wireless link or channel 1054. A relative position and orientation may include, but is not limited to including, a horizontal position relative to an x-axis or a y-axis, and/or a vertical position.

Once vehicle 1001 determines the relative position and orientation of device 1046, vehicle 1001 may determine its own position and orientation, and take autonomous actions that are directed substantially directionally towards device 1046. That is, vehicle 1001 may use localization information in part to determine actions to take and how to take those actions. For example, based on the location of customer device 1046 relative to vehicle 1001, vehicle 1001 may direct a light or audio sounds in the direction of customer device 1046. Vehicle 1001 may also change the intensity of light or the volume of audio sounds based on the location of customer device 1046.

A vehicle which is UWB-enabled or otherwise supports UWB communications may be arranged to communicate with a customer device to obtain data, and may use the obtained data to effectively identify a trajectory associated with the position of the customer device. Using a determined trajectory, the vehicle may be able to substantially predict where the customer device is likely to be at a particular point in time. That is, the vehicle may be able to substantially predict the behavior of a customer in possession of the customer device. Information regarding where a customer device is anticipated to be located at a certain time may be used to facilitate the positioning of the vehicle such that a customer who is in possession of the customer device may be able to efficiently retrieve his or her delivery from the vehicle.

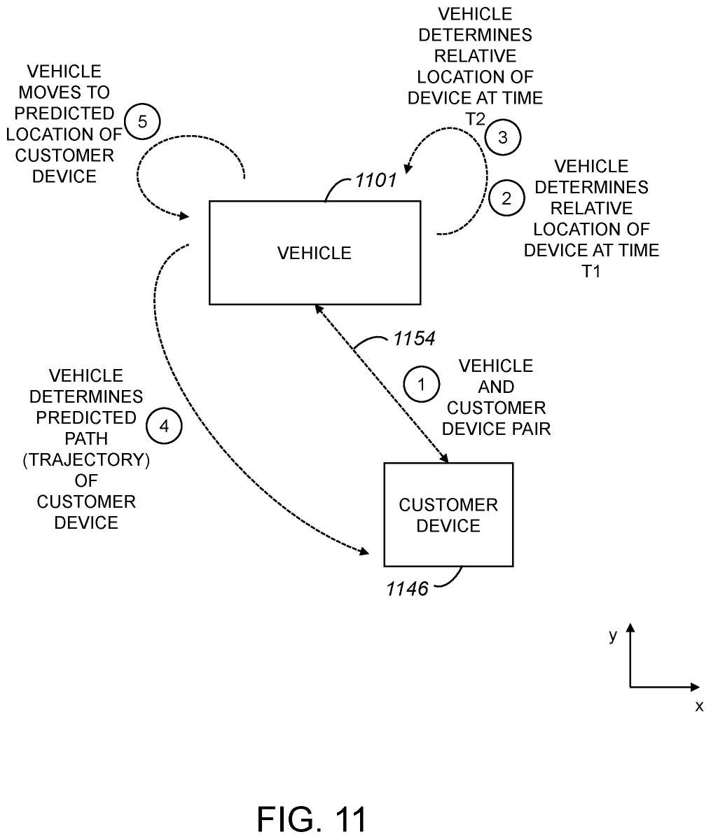

FIG. 11 is a diagrammatic representation of a vehicle paired to a customer device such that the vehicle may communicate with the customer device to predict a path or trajectory of the customer device in accordance with an embodiment. A UWB-enabled vehicle 1101 and a UWB-enabled customer device 1146 may be paired to enable UWB communications over wireless link or channel 1154. Upon a pairing between vehicle 1101 and device 1146, vehicle 1101 may determine the relative location of device 1146 relative to vehicle 1101 at a time t1. In one embodiment, such a determination may be made based on localization information obtained using sensors of vehicle 1101 and/or information provided by device 1146 through wireless link or channel 1154. A relative location may include, but is not limited to including, a horizontal position relative to an x-axis or a y-axis, and/or a vertical position, as well as an approximate distance between vehicle 1102 and device 1146. The relative location may also include an approximate angle of arrival associated with a signal received by vehicle 1101 from device 1146.

Once vehicle 1101 determines the relative location of device 1146 at time t1, vehicle 1101 may determine its own position and orientation, and may determine a relative location of device 1146 at a time t2. By tracking the location of device 1146 over time, e.g., over two or more points in time, vehicle 1101 may effectively calculate a direction in which device 1146 is moving, and a velocity at which device 1146 is moving. That is, computing systems onboard or otherwise associated with vehicle 1101 may predict a path or trajectory of device 1146.

After obtaining relative location information from device 1146 associated with two or more points in time, vehicle 1101 may determine the predicted path or trajectory of device 1146. Then, using the predicted path of device 1146, vehicle 1101 may move to the approximately final predicted location or destination of device 1146.

As will be appreciated by those skilled in the art, after vehicle 1101 moves to a predicted location of device 1146, vehicle 1101 may continue to monitor device 1146. In the event that a predicted path or trajectory of device 1146 changes based upon current locations of device 1146, computing systems onboard or otherwise associated with vehicle 1101 may update the predicted path or trajectory of device 1146, and vehicle 1101 may move to an updated predicted location of device 1146.

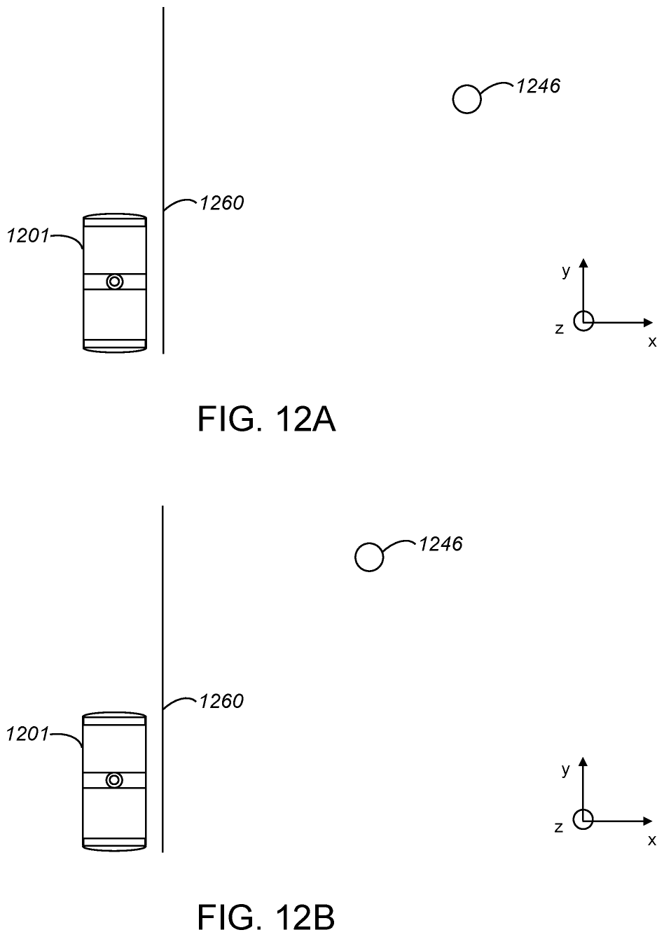

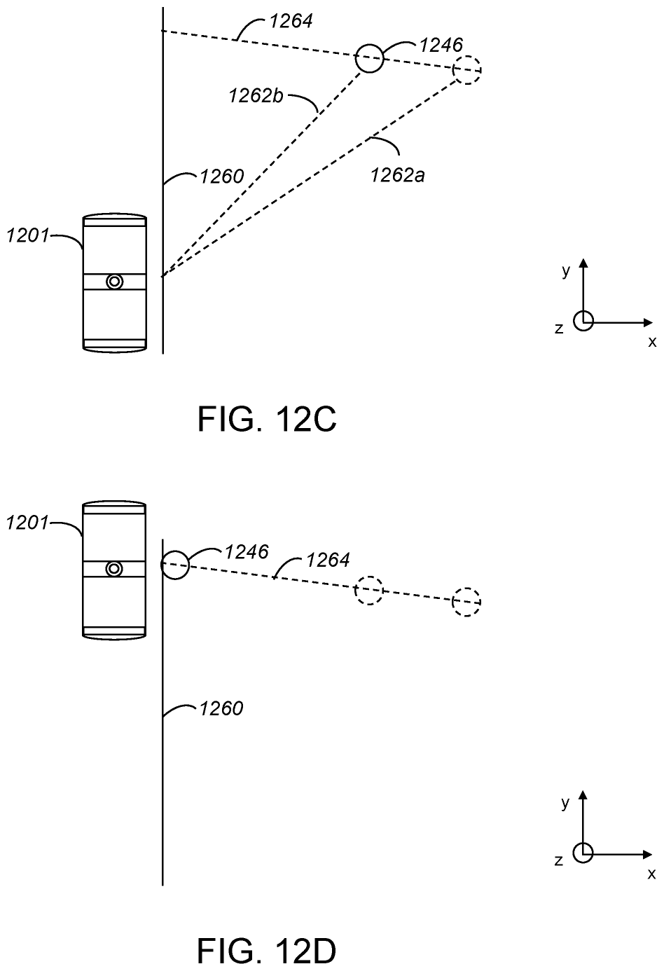

With reference to FIGS. 12A-D, the movement of a vehicle and a customer device will be described in accordance with an embodiment. FIG. 12A is a diagrammatic representation of a vehicle and a customer device at a time t1 in accordance with an embodiment. At a time t1, a UWB-enabled vehicle 1201 is positioned alongside a feature 1260, e.g., a curb at the side of a roadway. Vehicle 1201 may be an autonomous delivery vehicle, although it should be appreciated that vehicle 1201 is not limited to being an autonomous delivery vehicle. A UWB-enabled device 1246, which may be a device such as a smartphone in the possession of a customer, is located within a range of vehicle 1201 such that vehicle 1201 and device 1246 may effectively be paired such that vehicle 1201 and device 1246 may exchange information using UWB communications. At time t2, device 1246 may be in a first location.

At a time t2, device 1246 has moved to a second location, as shown in FIG. 12B. FIG. 12C shows a predicted path or trajectory for device 1246 based on the location of device 1246 at times t1 and t2 in accordance with an embodiment. Using information 1262a associated with a first location of device 1246 at time t1 and information 1262b associated with device 1246 at time t2, a predicted path 1264 may be identified. Information 1262a, 1262b may effectively include, but is not limited to including, a distance between device 1246 and vehicle 1201 along with an angle of arrival, which may be used to substantially derive positioning information and/or coordinates of the first and second locations. It should be appreciated that data obtained from sensors on vehicle 1201 may be utilized in addition to information 1262a, 1262b. By way of example, a camera (not shown) on vehicle 1201 may identify a path such as a sidewalk that device 1246 is on, and may use the shape of the path to improve the accuracy of predicted path or trajectory for device 1246.

With reference to FIG. 12D, the positioning of vehicle 1201 and device 1246 at a time t4 will be discussed in accordance with an embodiment. At a time t4, using predicted path 1264, vehicle 1201 has positioned itself near a terminus or an endpoint associated with predicted path 1264. In the described embodiment, the substantially final destination of device 1246 along predicted path 1264 is a location along feature 1260. Vehicle 1201 is positioned near the endpoint associated with predicted path 1264 such that a customer in possession of device 1256 may readily access vehicle 1201.

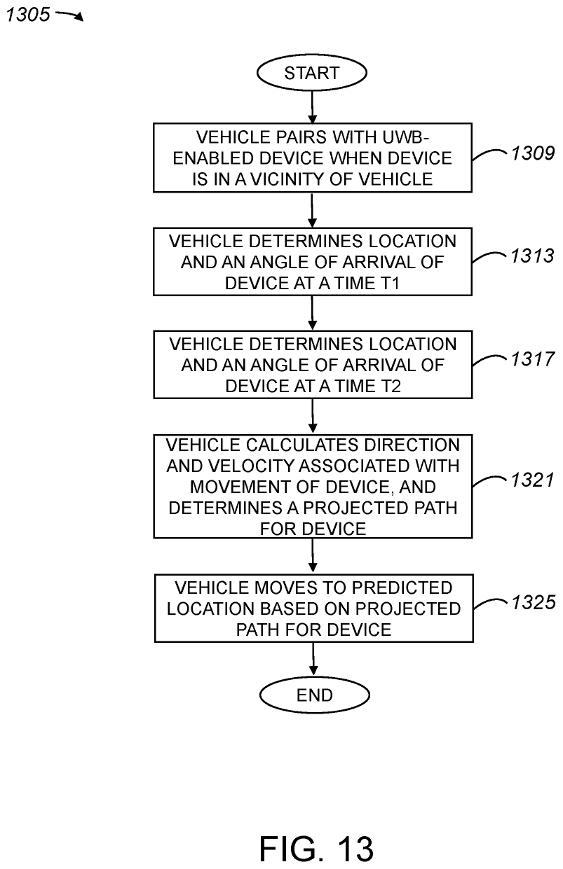

FIG. 13 is a process flow diagram which illustrates a method of positioning a vehicle relative to a customer device based on a predicted trajectory of the customer device in accordance with an embodiment. A method 1305 of positioning a vehicle begins at a step 1309 in which a UWB-enabled vehicle pairs with a UWB-enabled device when the device is in a vicinity of or within a predetermined range around the vehicle.

In a step 1313, the vehicle determines a location and an angle of arrival associated with the device at a time t1. Then, after an amount of time has elapsed, the vehicle determines a location and an angle of arrival associated with the device at a time t1 in a step 1317.

After the vehicle determines locations of the device at least at times t1 and t2, a direction of movement of the device, as well as the velocity of the device, may be substantially calculated in a step 1321. In general, the location of the device at time t1 and the location of the device at time t2, in addition to the time difference between t1 and t2, the direction of movement of the device and the velocity at which the device is moving may be determined. Using the direction of movement and the velocity of the devices, a projected path for the device may be identified. In one embodiment, the projected path may terminate at a location or position at which the device is likely to be located when a possessor of the device interacts with the vehicle.

From step 1321, process flow proceeds to a step 1325 in which the vehicle moves, e.g., autonomously travels or drives to a location based on the projected path of the device. The location to which the vehicle drives may correspond to an approximate intersection point between the projected path of the device and a path along which the vehicle is travelling. Once the vehicle moves to the predicted location, the method of positioning a vehicle is completed. As will be appreciated by those skilled in the art, the steps associated with method 1305 may be substantially repeated continuously such that the vehicle may move to new predicted locations as the device moves.

UWB communications generally utilized a relatively low amount of power. In one embodiment, a UWB system may be powered using a relatively small battery. As a result, when a vehicle with a UWB system generally loses power, the UWB system may still be utilized. By way of example, if cellular modems or other modes of communication are offline or otherwise suffer a failure, UWB may provide a relatively lower power backup system for communications.

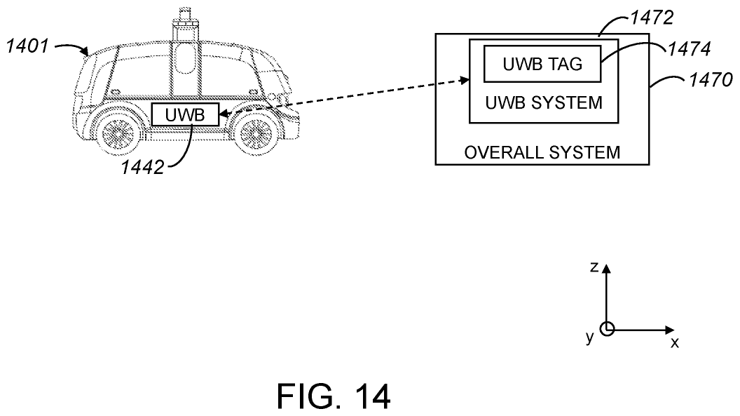

FIG. 14 is a diagrammatic representation of a vehicle with UWB capabilities which may communicate with an overall system that includes a UWB system which includes at least one UWB tag in accordance with an embodiment. A vehicle 1401 which includes a UWB system or sensor 1442 may communicate with an overall system 1470 which includes a UWB system 1472. That is, vehicle 1401 and overall system 1470 may engage in UWB communications using UWB system 1442 and UWB system 1472, respectively, as for example when other methods of communication are not tenable or are otherwise unavailable.

Vehicle 1401 may upload or otherwise transfer data stored there on to overall system 1470 using UWB communications. The transfer of data may either be initiated by vehicle 1401 or by overall system 1470. Overall system 1470, for example, may effectively pull diagnostic information from vehicle 1401 and may issue remote commands to vehicle 1401. Remote commands may include, but are not limited to including, power cycling commands, arming and disarming commands, and/or compartment access commands.

In one embodiment, UWB system 1472 may include a UWB tag or anchor 1474. UWB tag 1474 may generally be an electronic tag or board which supports UWB communications, and is positioned on or in overall system 1470 which such that tracking is substantially supported. The use of UWB tag 1474 may facilitate location tracking, or localization and/or a determination of relative positioning between vehicle 1401 and overall system 1470. Typically, UWB tag 1474 may emit UWB pulses that may be obtained by UWB system 1472. The pulses may effectively provide information that is used by UWB system 1472 to determine where UWB system 1472 is located or, more generally, where vehicle 1401 is located relative to UWB tag 1474. It should be appreciated that tag 1474 and UWB system 1472 will generally exchange pulses, and that such an exchange is generally bidirectional. Such ranging communication may be performed by any suitable method, e.g., using time difference of arrival (TDoA) or two way ranging (TWR).

Overall system 1470 may generally be any suitable system with which vehicle 1401 may communicate through UWB communications. In general, overall system 1470 may be any system 1470 with respect to which vehicle 1401 may intend to position itself. For example, overall system 1470 may be a maintenance vehicle such as a tow truck which communicates with vehicle 1401 to facilitate the transport of vehicle 1401.

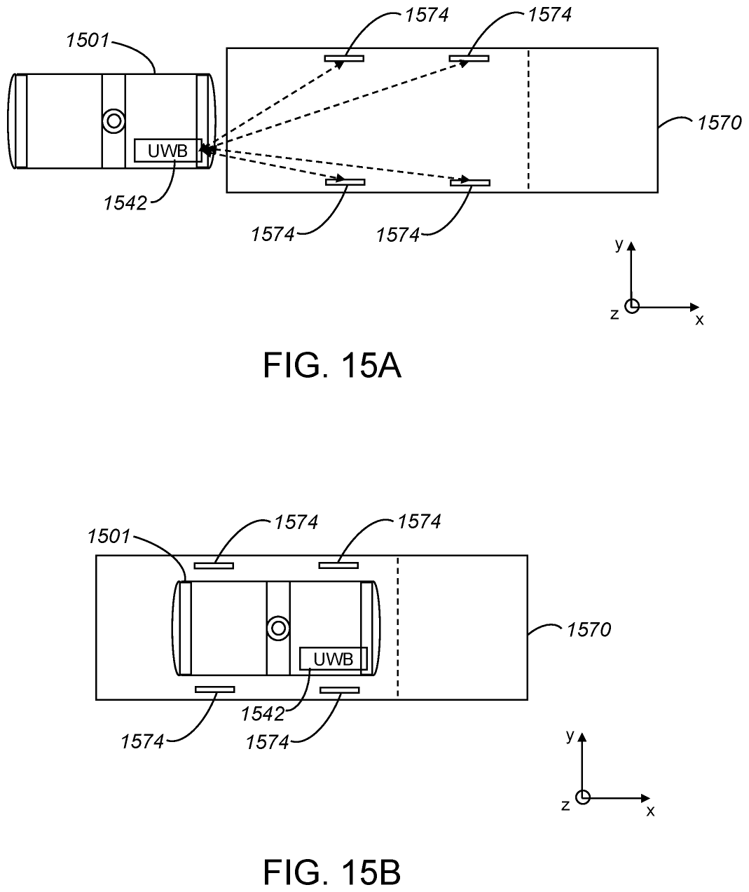

FIG. 15A is a diagrammatic overhead view representation of a vehicle interacting with UWB tags associated with a maintenance vehicle at a time t1 in accordance with an embodiment. At a time t1, a vehicle 1501 with a UWB system 1542 may communicate with a maintenance vehicle or truck 1570. A maintenance vehicle 1570 may be dispatched to a location at which vehicle 1501 is located, as for example if vehicle 1501 has encountered issues on the road.

Maintenance vehicle 1570 includes a plurality of UWB tags or anchors 1574, and may be configured to carry vehicle 1501 thereon, as for example on a flatbed portion of maintenance vehicle 1570. The number and location of UWB tags 1574 on maintenance vehicle 1570 may vary widely.

At time t1, vehicle 1501 is located near maintenance vehicle 1570, and vehicle 1501 and maintenance vehicle 1570 are exchanging information using UWB system 1542 and UWB tags 1574, respectively. Exchanging information may include UWB system 1542 communicating with UWB tags 1574 to localize the position of UWB system 1542 or, more generally, vehicle 1501 with respect to maintenance vehicle 1570. That is, UWB system 1542 may cooperate with UWB tags 1574 to enable vehicle 1570 to effectively drive onto maintenance vehicle 1570. A position on a transport surface of maintenance vehicle 1570 may be a desired location or desired destination for vehicle 1570. As shown in FIG. 15B, at a time t2, through the exchange of data between UWB system 1542 and UWB tags 1574, vehicle 1501 is effectively guided onto maintenance vehicle 1570 under its own power using localization. It should be appreciated that maintenance vehicle 1570 may include a ramp onto which vehicle 1501 may drive while UWB system 1542 and UWB tags 1574 engage in communications.

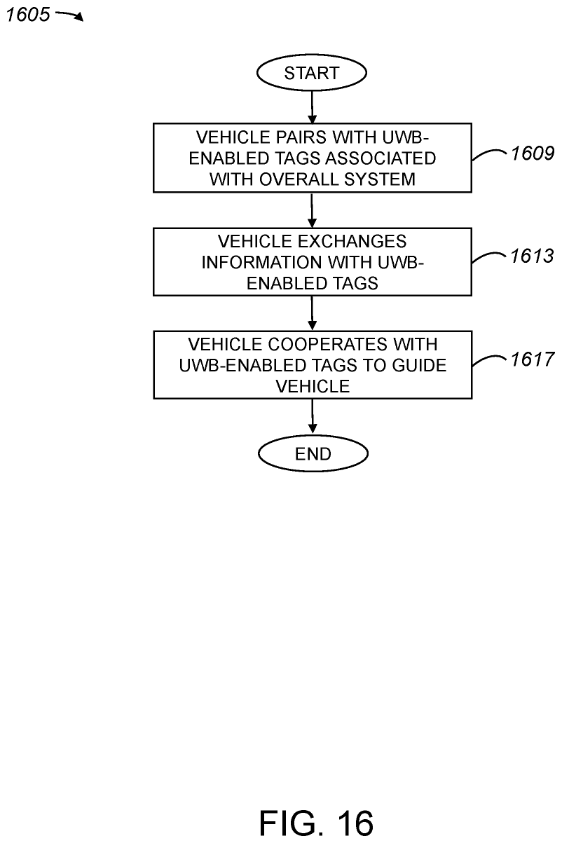

Referring next to FIG. 16, a method of a vehicle interacting with UWB tags will be described in accordance with an embodiment. A method 1605 of a vehicle interacting with one or more UWB tags begins at a step 1609 in which a vehicle pairs with UWB-enabled tags associated with an overall system, e.g., a maintenance vehicle. Once paired, in a step 1613, the vehicle exchanges information with the tags. The exchange of information may include the vehicle and the tags cooperating to determine a relative location of the vehicle with respect to the tags. Through the exchange of information, the vehicle may cooperate with the tags to substantially guide the vehicle to a desired destination and/or position in a step 1617. The exchange of information between the vehicle and the tags may guide the vehicle as the vehicle navigates to the desired destination. After the vehicle is guided into a desired destination, the method of a vehicle interacting with one or more UWB tags is completed.

In one embodiment, UWB communications may be used to facilitate the performance of an action by a UWB-enabled vehicle. A UWB-enabled device may communicate with the UWB-enabled vehicle to cause UWB-enabled vehicle to perform an action. Such communications may cause the UWB-enabled vehicle to substantially automatically perform an action, e.g., the vehicle may perform an action when the presence of the device is detected or otherwise sensed. For example, upon the device pairing with the vehicle, the vehicle may undertake an action such as providing access to a subcompartment on the vehicle when the device is less than a predetermined distance from the vehicle. It should be understood that providing access to a subcompartment may generally include unlocking and/or opening a door or covering on the compartment.

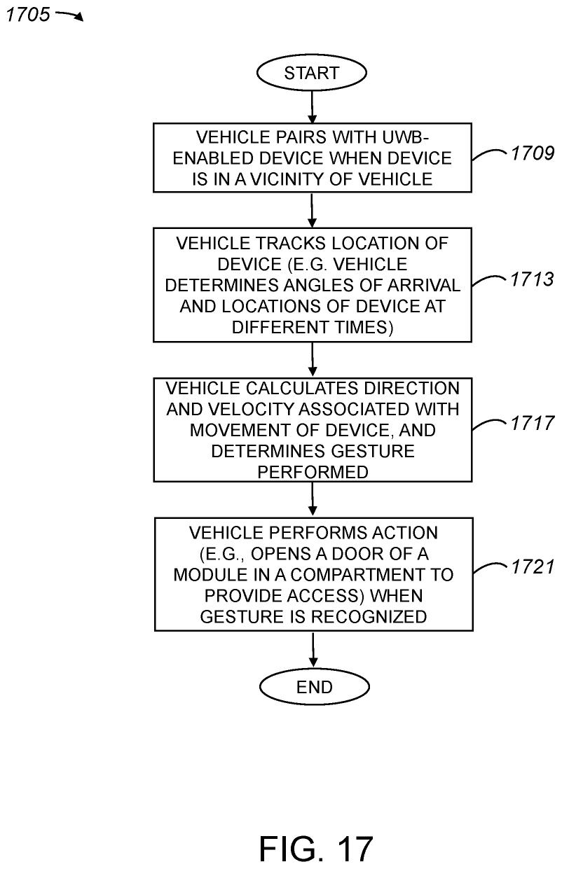

FIG. 17 is a process flow diagram which illustrates a method of a vehicle interacting with a UWB-enabled device to cause an action associated with the vehicle to be performed in accordance with an embodiment. A method 1705 of a vehicle performing an action in response to a presence of a device begins at a step 1709 in which a vehicle pairs with a UWB-enabled device when the device is in a vicinity, or within a pairing range, of the vehicle.

In a step 1713, the vehicle tracks the location of the device. Tracking the location of the device may include, but is not limited to including, exchanging data such as UWB time-of-flight data between the vehicle and the device. Such data may then be used, as for example by UWB modules, to determine angles of arrival of received UWB signals. Using the information obtained while tracking the location of the device, the vehicle calculates a direction and a velocity associated with the device in a step 1717, and determines a gesture performed using the device.

After the vehicle determines a gesture performed using the device, the vehicle performs an action when the gesture is recognized in a step 1712. In one embodiment, when the gesture is recognized as indicating that the action is to be taken and the device is within a predetermined distance from a particular location on the vehicle, the vehicle may perform the action. By way of example, when the device is within a predetermined distance from a subcompartment of a module in a compartment of the vehicle and the gesture is recognized as either an authentication of a possessor of the device or an acceptable command, the vehicle may cause the subcompartment to open. Upon performing the action, the method of a vehicle performing an action in response to a presence of a device is completed.

It should be appreciated that steps 1713 and 1717 of FIG. 17 may be optional. In one embodiment, a vehicle may perform an action when a device is detected at approximately a predetermined distance from the vehicle, and may not be based on a gesture performed using the device.

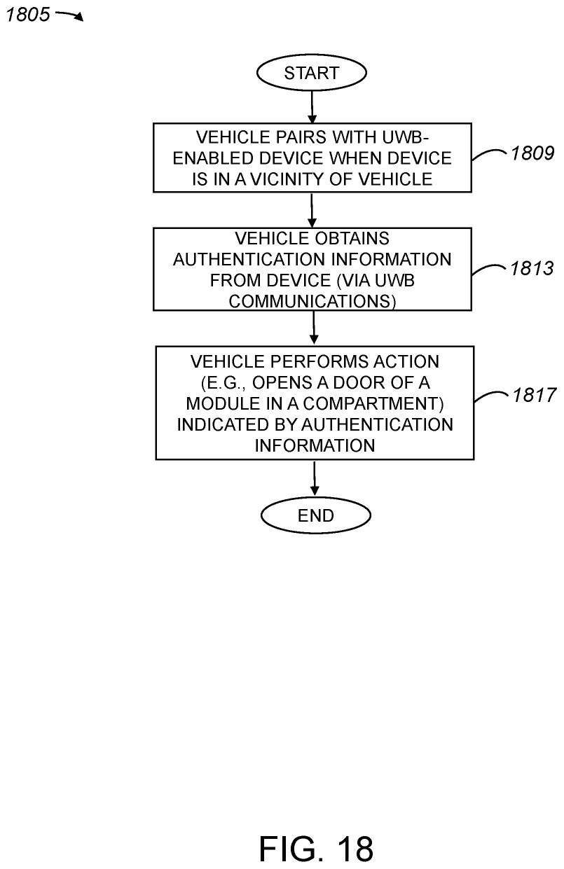

In lieu of a gesture being substantially detected by a vehicle, a gesture may instead be detected by a device, and the device may effectively notify the vehicle that a possessor of the device is effectively authenticated or legitimate. FIG. 18 is a process flow diagram which illustrates a method of a vehicle performing an action in response to obtaining authentication information from a UWB-enabled device in accordance with an embodiment. A method 1805 of a vehicle performing an action in response to obtaining authentication information begins at a step 1809 when a vehicle pairs with a UWB-enabled device when the device is in a vicinity of the vehicle. Once the vehicle and the device are paired, the vehicle obtains authentication information from the device via UWB communications in a step 1813.

In general, the device may authenticate a possessor of the device to substantially ensure that the possessor rightfully and legitimately has possession of the device. An authentication process on the device may include any suitable authentication process, e.g., entering a password or scanning facial features. In one embodiment, an authentication process may include gestures being performed while the device is held. For example, internal sensors of a device such as a smartphone or a smart watch may include an accelerometer configured to recognize specific gestures including, but not limited to including, swiping, tapping, and/or shaking. Once a gesture is recognized by the device, the device may provide authentication information to the vehicle using UWB communications.

In a step 1817, the vehicle performs an action indicated by the authentication information. The action performed may vary widely and may include, but is not limited to including, opening a door to a module in a compartment. After the vehicle performs the action, the method of a vehicle performing an action in response to obtaining authentication information.

Although only a few embodiments have been described in this disclosure, it should be understood that the disclosure may be embodied in many other specific forms without departing from the spirit or the scope of the present disclosure. By way of example, although the use of UWB communications has been described, other types of communications which allow for localization and ranged authentication may be used.

As mentioned above, when a UWB-enabled vehicle has power and/or network connectivity issues, the UWB-enabled vehicle may use UWB communications to offload data to a database, e.g., a database associated with a fleet management system or a maintenance system. Transferring data from a vehicle to a database using UWB communications is not limited to use when there are power and/or network connectivity issues. For instance, as a UWB-enabled vehicle drives into a warehouse or a depot, data from the vehicle may be offloaded to UWB devices at the warehouse or the depot. Such information may include information associated with compartments of a vehicle and/or general diagnostic information associated with the vehicle. The use of UWB communications may enable substantially direct communications between UWB devices and compartments or compartment modules on a vehicle, as for example when the compartments or compartment modules have UWB communications capabilities. Direct communications between UWB devices and compartment modules may facilitate the localization of the compartment modules, e.g., compartment modules may be located at a loading site and a vehicle may be able to readily locate the compartment modules to be loaded onto the vehicle.

An autonomous vehicle has generally been described as a land vehicle, or a vehicle that is arranged to be propelled or conveyed on land. It should be appreciated that in some embodiments, an autonomous vehicle may be configured for water travel, hover travel, and or/air travel without departing from the spirit or the scope of the present disclosure. In general, an autonomous vehicle may be any suitable transport apparatus that may operate in an unmanned, driverless, self-driving, self-directed, and/or computer-controlled manner.

The embodiments may be implemented as hardware, firmware, and/or software logic embodied in a tangible, i.e., non-transitory, medium that, when executed, is operable to perform the various methods and processes described above. That is, the logic may be embodied as physical arrangements, modules, or components. For example, the systems of an autonomous vehicle, as described above with respect to FIG. 3, may include hardware, firmware, and/or software embodied on a tangible medium. A tangible medium may be substantially any computer-readable medium that is capable of storing logic or computer program code which may be executed, e.g., by a processor or an overall computing system, to perform methods and functions associated with the embodiments. Such computer-readable mediums may include, but are not limited to including, physical storage and/or memory devices. Executable logic may include, but is not limited to including, code devices, computer program code, and/or executable computer commands or instructions.

It should be appreciated that a computer-readable medium, or a machine-readable medium, may include transitory embodiments and/or non-transitory embodiments, e.g., signals or signals embodied in carrier waves. That is, a computer-readable medium may be associated with non-transitory tangible media and transitory propagating signals.

The steps associated with the methods of the present disclosure may vary widely. Steps may be added, removed, altered, combined, and reordered without departing from the spirit of the scope of the present disclosure. Therefore, the present examples are to be considered as illustrative and not restrictive, and the examples are not to be limited to the details given herein, but may be modified within the scope of the appended claims.

What is claimed is:

1. A method comprising:
detecting, at a vehicle which includes an ultra-wideband (UWB) communications system, a presence of a first device;
pairing the vehicle and the first device, wherein pairing the vehicle and the first device causes the vehicle and the first device to communicate using UWB communications;
exchanging information between the vehicle and the first device using the UWB communications after the vehicle and the first device are paired; and
performing an action using the vehicle, wherein the action is based on the information.

2. The method of claim 1 wherein the vehicle is an autonomous or semi-autonomous vehicle, the method further including:
determining, using the information, a trajectory associated with the first device; and
determining a vehicle location for the vehicle based on the trajectory associated with the first device, wherein performing the action using the vehicle includes causing the vehicle to travel to the vehicle location.

3. The method of claim 2 wherein exchanging the information includes obtaining, at the vehicle, a first information from the first device at a first time which includes a first location and a first angle of arrival, and obtaining, at the vehicle, a second information from the first device at a second time which includes a second location and a second angle of arrival, and wherein determining the trajectory includes calculating a direction and a velocity associated with the first device using at least the first information and the second information.

4. The method of claim 1 wherein the vehicle is an autonomous or semi-autonomous vehicle, and wherein the first device is a first UWB tag, the method further including:
determining, using the information, how to navigate the vehicle to a desired location, wherein performing the action using the vehicle includes navigating the vehicle to the desired location.

5. The method of claim 4 further including:
pairing the vehicle and a second UWB tag, wherein pairing the vehicle and the second UWB tag causes the vehicle and the second UWB tag to communicate using UWB communications, wherein exchanging the information includes exchanging the information between the vehicle and the second device.

6. The method of claim 5 wherein the first UWB tag and the second UWB tag are included on a maintenance vehicle, and wherein the desired location is a position on the maintenance vehicle.

7. The method of claim 1 wherein the vehicle is an autonomous or semi-autonomous vehicle, the vehicle including at least one compartment, and wherein the action includes providing access to the at least one compartment.

8. The method of claim 7 wherein exchanging the information includes authenticating the first device, wherein the access is provided to the at least one compartment after the first device is authenticated.

9. The method of claim 1 wherein in the vehicle is an autonomous or semi-autonomous vehicle, the vehicle including a first compartment, the first compartment carrying a first module that includes a first subcompartment, and wherein the action includes providing access to the first subcompartment.

10. The method of claim 9 the vehicle is an autonomous or semi-autonomous vehicle, and wherein exchanging the information includes the vehicle obtaining information that indicates a gesture associated with the first device, the method further including:
authenticating the gesture, wherein the action is performed when the gesture is authenticated.

11. A vehicle comprising:
a chassis;
a propulsion system carried on the chassis, the propulsion system configured to enable the vehicle to travel;
a navigation system carried on the chassis, the navigation system arranged to cooperate with the propulsion system to navigate the vehicle; and
an ultra-wideband (UWB) system, the UWB system carried on the chassis, the UWB system configured to support UWB communications, the UWB system further configured to process information included in the UWB communications to cause the vehicle to perform an action.

12. The vehicle of claim 11 wherein the UWB system is configured to obtain the information from a first UWB device, and wherein the UWB system is configured to pair the vehicle with the first UWB device when the first UWB device is within a predetermined distance from the vehicle.

13. The vehicle of claim 12 wherein the vehicle includes at least one compartment carried on the chassis, and wherein the action includes unlocking the at least one compartment.

14. A system comprising:
a vehicle, the vehicle including an ultra-wideband (UWB) system, the UWB system configured to support UWB communications, the UWB system further configured to process information included in the UWB communications to cause the vehicle to perform an action; and
a first UWB device, the first UWB device arranged to pair with the vehicle when the first UWB device is within a vicinity of the vehicle, wherein when the first UWB device is paired with the vehicle, the vehicle and the first UWB device exchange information using UWB communications, wherein the vehicle is configured to perform an action based on the information.

15. The system of claim 14 wherein the vehicle is an autonomous or semi-autonomous vehicle, the vehicle being configured to determine, using the information, a trajectory associated with the first UWB device, the vehicle further being configured to determine a vehicle location for the vehicle based on the trajectory, and wherein the action includes the vehicle travelling to the vehicle location.

16. The system of claim 15 wherein the information includes a first information and a second information, the first information being a first time which includes a first location and a first angle of arrival associated with the first UWB device, the second information being a second location and a second angle of arrival associated with the first UWB device, and wherein the trajectory is determined by calculating a direction and a velocity associated with the first UWB device using at least the first information and the second information.

17. The system of claim 14 wherein the vehicle is an autonomous or semi-autonomous vehicle and the first UWB device is a first UWB tag, the vehicle being configured to determine, using the information, how to navigate to a desired location, wherein the action includes navigating to the desired location.

18. The system of claim 17 further including:
a second UWB device, the second UWB device arranged to pair with the vehicle when the second UWB device is within the vicinity of the vehicle, wherein when the second UWB device is paired with the vehicle, the vehicle and the second UWB device exchange information using the UWB communications.

19. The system of claim 14 wherein the vehicle is an autonomous or semi-autonomous vehicle, and wherein the vehicle includes at least one compartment, the action including providing access to the at least one compartment.

20. The system of claim 19 wherein the information includes information associated with authenticating the first UWB device, wherein the access is provided after the first UWB device is authenticated.
